(19) United States
(12) Patent Application Publication
(10) Pub. No.: US 2017/0228295 A1
(43) Pub. Date: Aug. 10, 2017

(54) COMPUTER-READABLE RECORDING MEDIUM, RESTORATION PROCESS CONTROL METHOD, AND INFORMATION PROCESSING DEVICE

(71) Applicant: FUJITSU LIMITED, Kawasaki-shi (JP)

(72) Inventors: Tomohiro Yoshimitsu, Numadu (JP); TAKEHIRO IDE, Mishima (JP)

(73) Assignee: FUJITSU LIMITED, Kawasaki-shi (JP)

(21) Appl. No.: 15/402,363

(22) Filed: Jan. 10, 2017

(30) Foreign Application Priority Data
Feb. 10, 2016 (JP) 2016-024161

(51) Int. Cl. G06F 11/14; G06F 9/455; G06F 9/445

(52) U.S. Cl. CPC G06F 11/1469; G06F 11/1461; G06F 8/62; G06F 9/455; G06F 2201/84

(57) ABSTRACT

A snapshot creation unit creates snapshots for a virtual system respectively before and after installation of a function for the virtual system. As a problem occurs in the virtual system, an installation directory identification unit identifies an installation directory for a function with a problem having occurred therein, based on a difference between the snapshots respectively created before and after the installation. A virtual system restoration unit selectively executes a restoration process (rollback) for the installation directory identified by the installation directory identification unit when the restoration process for the virtual system is executed.

### CROSS-REFERENCE TO RELATED APPLICATION

This application is based upon and claims the benefit of priority of the prior Japanese Patent Application No. 2016-024161, filed on Feb. 10, 2016, the entire contents of which are incorporated herein by reference.

### FIELD

The embodiment discussed herein is related to a computer-readable recording medium, a restoration process control method, and an information processing device.

### BACKGROUND

For backup of an information processing device, a snapshot of the information processing device is obtained regularly and restoration that uses the snapshot is executed. For example, in cloud environment, a snapshot of the whole of a virtual system is obtained at a normal time, and as a problem occurs in the virtual system, returning to a state where the snapshot was obtained is executed by utilizing the snapshot obtained at the normal time.

There is a technique for temporarily saving a program installed in a computer, dynamically restoring the program as needed, and causing an unutilized program to remain saved or deleting such a program after a lapse of a certain period of time, so that effective utilization of a computer resource is attained.

For reliability measurement of software, there is a technique for capturing a first snapshot of a software state of a machine prior to installation of software into the machine and capturing a second snapshot of a software state of the machine after the installation.

There is a technique for changing a name of a module set to be installed according to a certain rule when a device driver is installed, so that appropriate installation is executed.

Japanese Laid-open Patent Publication No. 10-333891

Japanese Laid-open Patent Publication No. 2010-92469

Japanese Laid-open Patent Publication No. 2004-62397

### SUMMARY

According to an aspect of an embodiment, a non-transitory computer-readable recording medium having stored therein a program that causes a computer to execute a process including: acquiring snapshots for an information processing device respectively before and after installation of software for the information processing device; identifying an installation directory for the software based on a difference between the snapshots respectively acquired before and after the installation; and selectively executing a restoration process for the identified installation directory when executing the restoration process for the software.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating obtainment of snapshots according to an embodiment;

FIG. 2 is a diagram illustrating a restoration method according to an embodiment;

FIG. 3 is a diagram illustrating restoration of a resource in another directory;

FIG. 4 is a diagram illustrating a configuration of a server according to an embodiment;

FIG. 5 is a diagram illustrating identification of an installation directory by an installation directory identification unit;

FIG. 6 is a diagram illustrating a method for identifying a resource in another directory;

FIG. 7 is a flowchart illustrating a flow of a process for restoration;

FIG. 8 is a flowchart illustrating a flow of a restoration process in a case where a restoration resource is only an installation directory resource;

FIG. 9 is a flowchart illustrating a flow of a restoration process in a case where a restoration resource includes a resource in another directory other than an installation directory resource;

FIG. 10 is a diagram illustrating a hardware configuration of a server that executes a restoration process control program according to an embodiment; and

FIG. 11 is a diagram illustrating a problem in restoration that uses a snapshot.

### DESCRIPTION OF EMBODIMENT

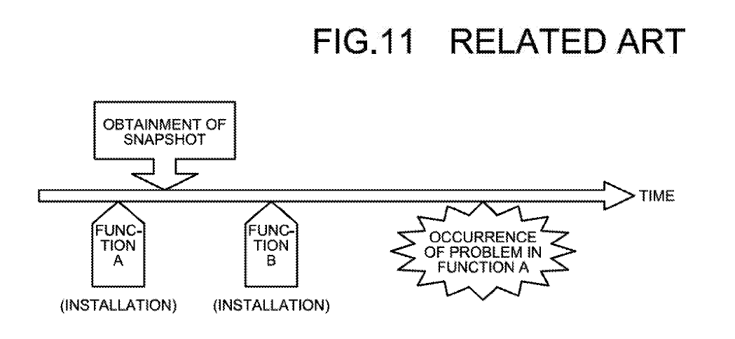

However, in restoration of the whole that uses a snapshot, there is a problem in that a function installed after obtainment of a snapshot is lost. Herein, a “function” is software. FIG. 11 is a diagram illustrating a problem in restoration that uses a snapshot.

As illustrated in FIG. 11, after a function A is installed, a snapshot of the whole is obtained, and subsequently, a function B is installed. Subsequently, as a problem occurs in the function A, the whole is restored by using the obtained snapshot. Then, the function B is not included in the obtained snapshot, and hence, the function B is lost.

A preferred embodiment of the present invention will be explained with reference to accompanying drawings. Such an embodiment does not limit the invention.

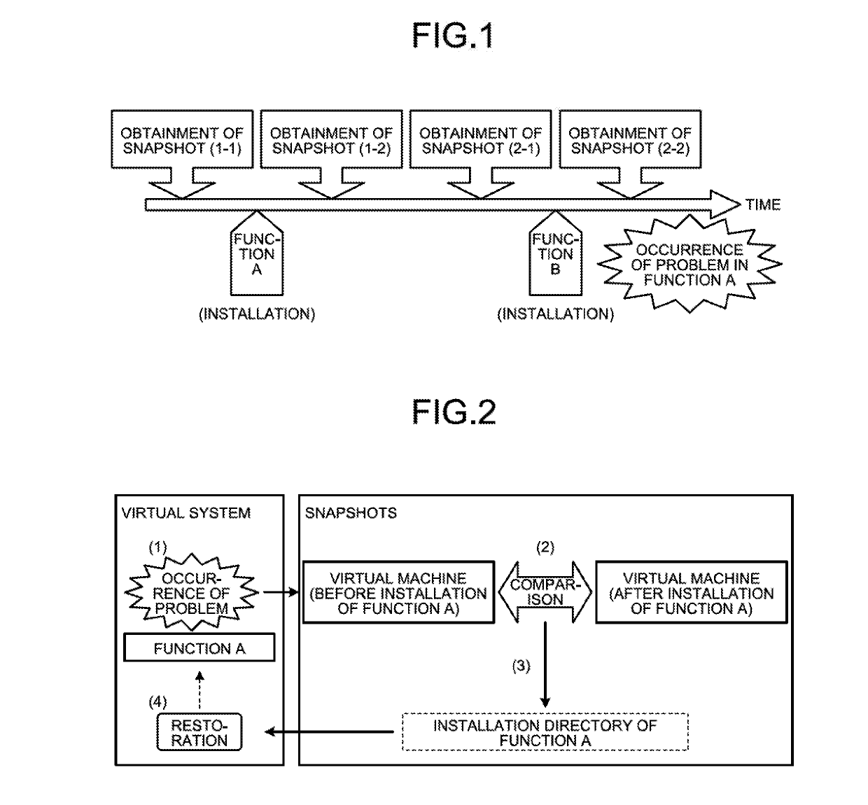

First, obtainment of snapshots and a restoration method according to the embodiment will be described. FIG. 1 is a diagram illustrating obtainment of snapshots according to the embodiment. As illustrated in FIG. 1, in obtainment of snapshots according to the embodiment, snapshots are obtained before and after installation of a function.

In FIG. 1, a snapshot is obtained (1-1) before a function A is installed, and a snapshot is obtained (1-2) after the function A is installed. A snapshot is obtained (2-1) before a function B is installed, and a snapshot is obtained (2-2) after the function B is installed.

As a problem occurs in the function A, restoration of the function A is executed by using snapshots before and after installation of the function A. FIG. 2 is a diagram illustrating a restoration method according to the embodiment. As illustrated in FIG. 2, a problem occurs in a function A (1). In a restoration method according to the embodiment, snapshots of a virtual machine before and after installation of the function A are compared with one another (2).

An installation directory of the function A is not present in a snapshot before installation of the function A but is present in a snapshot after installation of the function A, and hence, the installation directory of the function A is identified (3). The function A is restored by using the identified installation directory (4).

Thus, only a function with a problem having occurred therein is restored in restoration according to the embodiment, and hence, another function installed after installation of the function with the problem having occurred therein is not influenced thereby. Therefore, a restoration method according to the embodiment can prevent a loss of another function.

In a case where a function is installed, not only is an installation directory of the function added, but also a resource in another directory may be updated. Herein, a “resource” is an execution module for the function, a text file or setup file for the function, or the like. For example, as a function is installed, a setup file may be updated.

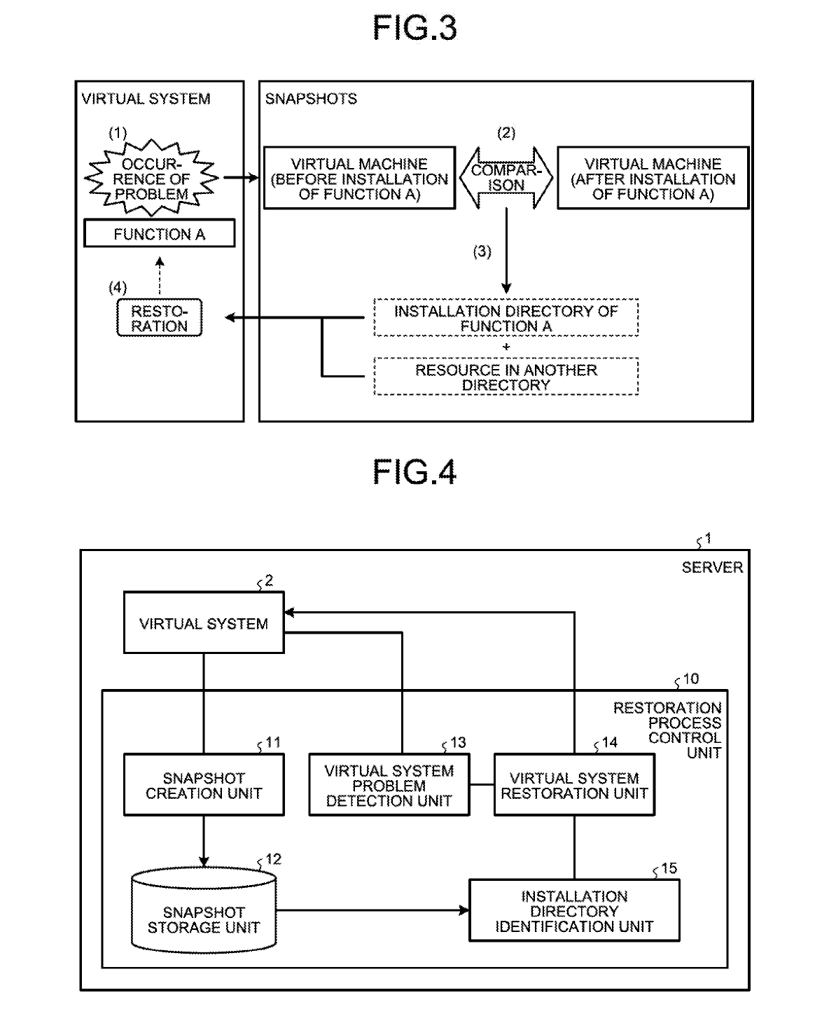

FIG. 3 is a diagram illustrating restoration of a resource in another directory. As illustrated in FIG. 3, in a case where a resource in another directory is updated when a function is installed, identification of the updated resource in another directory is also executed together with identification of an installation directory. The installation directory and the resource in another directory are restored.

Thus, a resource updated when a function is installed is also restored in restoration according to the embodiment, and hence, a function which updates a resource in another directory at a time of installation thereof can also be restored.

Next, a functional configuration of a server according to the embodiment will be described. FIG. 4 is a diagram illustrating a configuration of a server according to the embodiment. As illustrated in FIG. 4, a virtual system 2 and a restoration process control unit 10 operate in a server 1 according to the embodiment.

The virtual system 2 is a virtual system that is constructed on a physical server 1, and the virtual system 2 includes, for example, a plurality of virtual machines. The server 1 is virtualized, and thereby, for example, a plurality of virtual machines with different OSs operating therein can be realized on a single server 1. Each function operates on the virtual system 2.

The restoration process control unit 10 executes restoration for each function by using snapshots. The restoration process control unit 10 includes a snapshot creation unit 11, a snapshot storage unit 12, a virtual system problem detection unit 13, a virtual system restoration unit 14, and an installation directory identification unit 15.

The snapshot creation unit 11 creates snapshots of the whole of the virtual system 2 before and after each function is installed, and writes the snapshots into the snapshot storage unit 12. The snapshot storage unit 12 stores the snapshots therein.

As a problem occurs in a function that operates on the virtual system 2, the virtual system problem detection unit 13 detects occurrence of the problem and informs the virtual system restoration unit 14 of information of a function with the problem having occurred therein.

The virtual system restoration unit 14 restores a function with a problem having occurred therein, by using an installation directory identified by the installation directory identification unit 15. In a case where the installation directory identification unit 15 also identifies a resource in another directory, the virtual system restoration unit 14 also restores the resource in another directory.

The installation directory identification unit 15 reads snapshots before and after installation of a function with a problem having occurred therein from the snapshot storage unit 12, and compares the snapshots with one another. The installation directory identification unit 15 finds a difference between the snapshots before and after installation of the function with a problem having occurred therein, to identify an installation directory of the function with a problem having occurred therein, and informs the virtual system restoration unit 14 of the installation directory together with a resource thereunder.

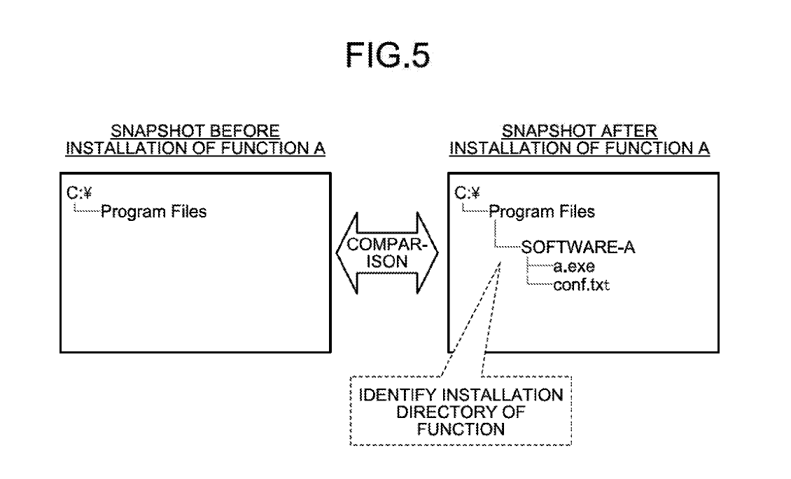

FIG. 5 is a diagram illustrating identification of an installation directory to be executed by the installation directory identification unit 15. As illustrated in FIG. 5, none of a directory of “SOFTWARE-A” and “a.exe” and “conf.txt” thereunder that are present in a snapshot after a function A is installed is present in a snapshot before the function A is installed. Herein, “SOFTWARE-A” is an installation directory of the function A.

Therefore, the installation directory identification unit 15 can compare the snapshots before and after the function A is installed with one another, and thereby, identify an installation directory “SOFTWARE-A” of the function A. The installation directory identification unit 15 can identify resources of “a.exe” and “conf.txt” under the installation directory “SOFTWARE-A” of the function A.

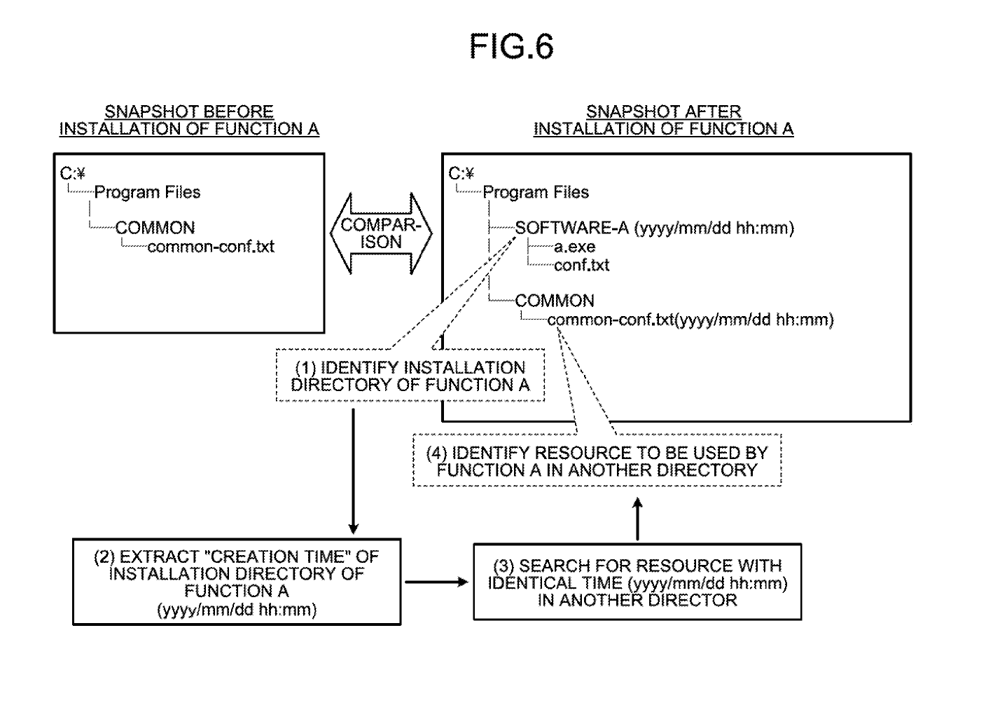

In a case where a resource in another directory is updated at a time of installation of a function, the installation directory identification unit 15 also identifies the updated resource in another directory. FIG. 6 is a diagram illustrating a method for identifying a resource in another directory.

As illustrated in FIG. 6, the installation directory identification unit 15 compares snapshots before and after a function A is installed with one another, and thereby, identifies an installation directory of the function A (1). The installation directory identification unit 15 extracts a creation time of the installation directory of the function A, from the snapshot after the function A is installed (2).

In FIG. 6, the creation time of the installation directory of the function A is represented by “yyyy/mm/dd hh:mm”. Herein, “yyyy” represents a Christian year, “mm” represents a month, “dd” represents a day, “hh” represents an hour, and “mm” represents a minute.

The installation directory identification unit 15 searches for a resource with an update time that is identical to “yyyy/mm/dd hh:mm” in another directory, from the snapshot after the function A is installed (3).

The installation directory identification unit 15 identifies the resource with an update time that is identical to “yyyy/mm/dd hh:mm” in another directory as a resource to be used by the function A in another directory (4). The installation directory identification unit 15 may identify a plurality of resources to be used by the function A in another directory.

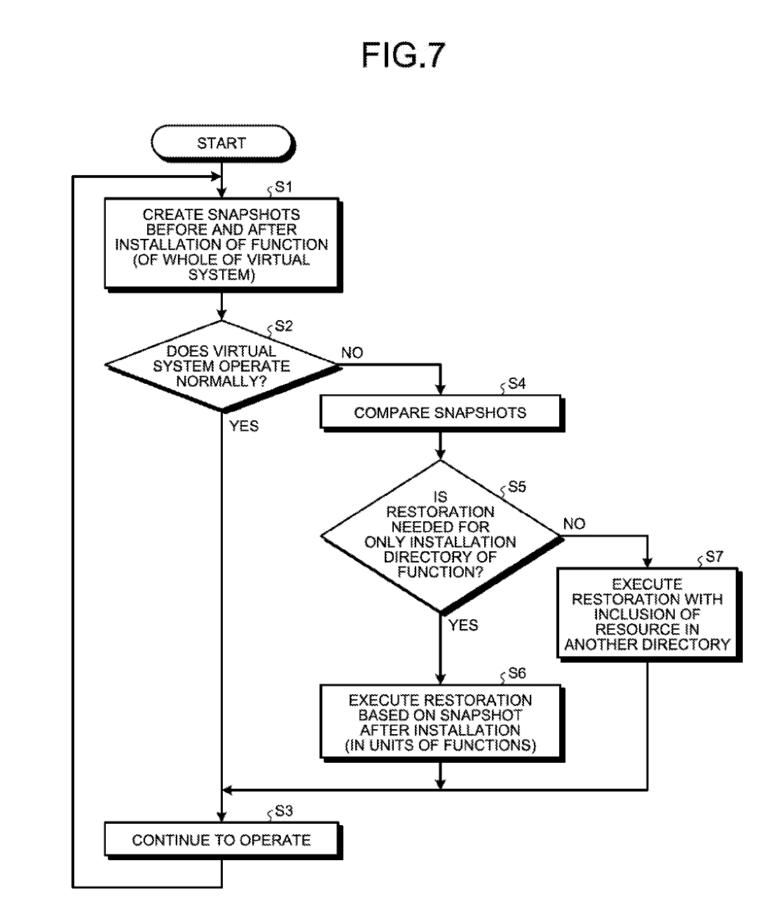

Next, a flow of a process for restoration will be described. FIG. 7 is a flowchart illustrating a flow of a process for restoration. As illustrated in FIG. 7, the snapshot creation unit 11 creates snapshots of the whole of the virtual system 2 before and after installation of a function (step S1).

Then, the virtual system problem detection unit 13 determines whether or not the virtual system 2 operates normally (step S2), and in a case where the virtual system 2 operates normally, the virtual system 2 continues to operate (step S3) and the process returns to step S1.

On the other hand, in a case where the virtual system 2 does not normally operate, the installation directory identification unit 15 compares snapshots before and after installation of a function with a problem having occurred therein, with one another (step S4), and identifies an installation directory of the function with a problem having occurred therein.

Then, the installation directory identification unit 15 determines whether or not restoration is needed for only the installation directory of the function with a problem having occurred therein (step S5). As a result, in a case where restoration is needed for only the installation directory of the function with a problem having occurred therein, the virtual system restoration unit 14 restores the virtual system 2 based on a snapshot after installation of the function with a problem having occurred therein (step S6). That is, restoration is executed function by function. Then, the process moves to step S3.

On the other hand, in a case where restoration is also needed for other than the installation directory of the function with a problem having occurred therein, the virtual system restoration unit 14 executes restoration with the inclusion of a resource in another directory (step S7), and the process moves to step S3.

Thus, the installation directory identification unit 15 determines whether or not restoration is needed for only an installation directory of a function with a problem having occurred therein, and thereby, the restoration process control unit 10 can appropriately execute restoration of the virtual system 2.

Next, a flow of a restoration process in a case where a restoration resource is only an installation directory resource will be described. Herein, an “installation directory resource” is a resource that is present under an installation directory.

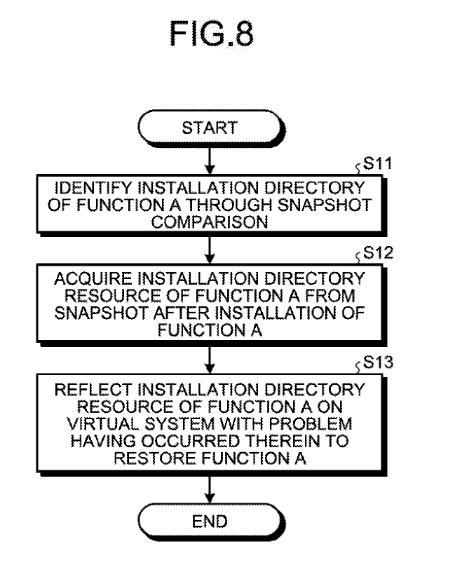

FIG. 8 is a flowchart illustrating a flow of a restoration process in a case where a restoration resource is only an installation directory resource. A process as illustrated in FIG. 8 corresponds to processes at step S4 and step S6 as illustrated in FIG. 7.

As illustrated in FIG. 8, the installation directory identification unit 15 identifies an installation directory of a function A through snapshot comparison (step S11). Herein, the function A is a function with a problem having occurred therein.

Then, the installation directory identification unit 15 acquires an installation directory resource of the function A from a snapshot after installation of the function A (step S12). Then, the virtual system restoration unit 14 reflects the installation directory resource of the function A on the virtual system 2 with a problem having occurred therein, so that the function A is restored (step S13).

Thus, the installation directory identification unit 15 compares snapshots before and after installation of a function with a problem having occurred therein, with one another, and identifies an installation directory of the function with a problem having occurred therein, so that the restoration process control unit 10 can restore only the function with a problem having occurred therein.

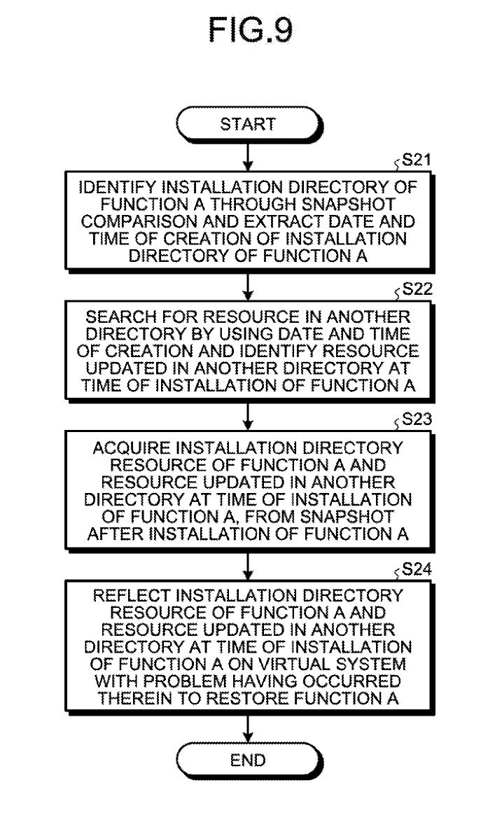

Next, a flow of a restoration process in a case where a restoration resource includes a resource in another directory other than an installation directory resource will be described. FIG. 9 is a flowchart illustrating a flow of a restoration process in a case where a restoration resource includes a resource in another directory other than an installation directory resource. A process as illustrated in FIG. 9 corresponds to processes at step S4 and step S7 as illustrated in FIG. 7.

As illustrated in FIG. 9, the installation directory identification unit 15 identifies an installation directory of a function A through snapshot comparison and extracts a date and a time of creation of the installation directory of the function A (step S21). Herein, the function A is a function with a problem having occurred therein.

Then, the installation directory identification unit 15 searches for a resource in another directory by using the extracted date and time of creation and identifies a resource updated in another directory at a time of installation of the function A (step S22).

Then, the installation directory identification unit 15 acquires an installation directory resource of the function A and the resource updated in another directory at a time of installation of the function A, from a snapshot after installation of the function A (step S23).

Then, the virtual system restoration unit 14 reflects the installation directory resource of the function A and the resource updated in another directory at a time of installation of the function A on the virtual system 2 with a problem having occurred therein, so that the function A is restored (step S24).

Thus, the installation directory identification unit 15 identifies a resource updated in another directory at a time of installation of a function with a problem having occurred therein, so that the restoration process control unit 10 can appropriately restore the function with a problem having occurred therein.

As has been described above, in the embodiment, the snapshot creation unit 11 creates snapshots for the virtual system 2 both before and after installation of a function for the virtual system 2. As a problem occurs in the virtual system 2, the installation directory identification unit 15 identifies an installation directory for a function with a problem having occurred therein, based on a difference between the snapshots before and after the installation. The virtual system restoration unit 14 selectively executes a restoration process (rollback) for the installation directory identified by the installation directory identification unit 15 when the restoration process for the virtual system 2 is executed.

Therefore, the restoration process control unit 10 can execute a restoration process narrowed down to a function as a restoration target and can prevent a loss of another function installed after installation of a function with a problem having occurred therein.

In the embodiment, the installation directory identification unit 15 identifies another directory with a content rewritten at a time of installation of a function with a problem having occurred therein. The virtual system restoration unit 14 also executes a restoration process for another directory identified by the installation directory identification unit 15. Therefore, the restoration process control unit 10 can appropriately restore the function with a problem having occurred therein.

In the embodiment, the installation directory identification unit 15 identifies another directory with a content rewritten at a time of installation of a function with a problem having occurred therein, based on a creation time of an installation directory of the function with a problem having occurred therein. Therefore, the restoration process control unit 10 can accurately identify another directory with a content rewritten at a time of installation of the function with a problem having occurred therein.

In the embodiment, the restoration process control unit 10 has been described, and the restoration process control unit 10 is realized by software. A hardware configuration of the server 1 will be described that executes a restoration process control program that realizes the restoration process control unit 10.

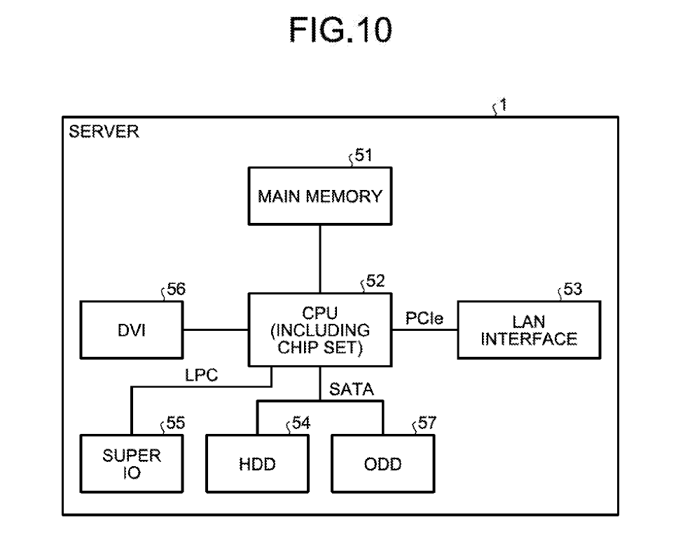

FIG. 10 is a diagram illustrating a hardware configuration of the server 1 that executes a restoration process control program according to the embodiment. As illustrated in FIG. 10, the server 1 includes a main memory 51, a CPU 52, a Local Area Network (LAN) interface 53, and a Hard Disk Drive (HDD) 54. The server 1 also includes a super Input Output (IO) 55, a Digital Visual Interface (DVI) 56, and an Optical Disk Drive (ODD) 57.

The main memory 51 is a memory that stores a program, an interim result of execution of the program, and the like. The CPU 52 is a central processing unit that reads a program from the main memory 51 and executes the program. The CPU 52 includes a chip set that includes a memory controller.

The LAN interface 53 is an interface for connecting the server 1 to another computer through a LAN. The HDD 54 is a disk device that stores a program or data and the super IO 55 is an interface for connecting an input device such as a mouse or a keyboard to the server 1. The DVI 56 is an interface that connects a liquid crystal display device to the server 1 and the ODD 57 is a device that executes reading or writing for a DVD.

The LAN interface 53 is connected to the CPU 52 through a PCI Express (PCIe) and the HDD 54 and the ODD 57 are connected to the CPU 52 through a Serial Advanced Technology Attachment (SATA). The super IO 55 is connected to the CPU 52 through a Low Pin Count (LPC).

A restoration process control program that is executed in the server 1 is stored in a DVD, read from the DVD by the ODD 57, and installed in the server 1. Alternatively, a restoration process control program is stored in a database of another computer system connected to the server 1 through the LAN interface 53 or the like, read from such a database, and installed in the server 1. The installed restoration process control program is stored in the HDD 54, read into the main memory 51, and executed by the CPU 52.

According to one aspect of the embodiment, a loss of a function can be prevented in a restoration process.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
acquiring snapshots for an information processing device respectively before and after installation of software for the information processing device;
identifying an installation directory for the software based on a difference between the snapshots respectively acquired before and after the installation; and
selectively executing a restoration process for the identified installation directory when executing the restoration process for the software.

2. The non-transitory computer-readable recording medium according to claim 1, the process further comprising:
identifying another directory in which a content was rewritten at a time of the installation of the software; and
also executing a restoration process for the identified other directory.

3. The non-transitory computer-readable recording medium according to claim 2, wherein the identifying another directory is executed based on a creation time of the installation directory.

4. A restoration process control method executed by a computer; the restoration process control method including:
acquiring snapshots for an information processing device respectively before and after installation of software for the information processing device;
identifying an installation directory for the software based on a difference between the snapshots respectively acquired before and after the installation; and
selectively executing a restoration process for the identified installation directory when executing the restoration process for the software.

5. An information processing device comprising:
a processor that executes a process including:
acquiring snapshots for the information processing device respectively before and after installation of software for the information processing device;
identifying an installation directory for the software based on a difference between the snapshots respectively acquired before and after the installation; and
selectively executing a restoration process for the identified installation directory when executing the restoration process for the software.
